(19) United States
(12) Patent Application Publication
(10) Pub. No.: US 2008/0024884 A1
(43) Pub. Date: Jan. 31, 2008

(54) Magnifier for use with consumer electronic display devices

(76) Inventors: Patricia Rowe, Rochester, MI (US); Brandon Rowe, Lexington, KY (US)

Correspondence Address: CHRIS TANNER, 85 RIO ROBLES EAST # 2101, SAN JOSE, CA, 95134, US

(21) Appl. No.: 11/716,311

(22) Filed: Mar. 9, 2007

Related U.S. Application Data
(60) Provisional application No. 60/780,555, filed on Mar. 9, 2006.

(51) Int. Cl. G02B 25/00

(52) U.S. Cl. 359/818

(57) ABSTRACT

A magnifier for attaching to devices with a display is disclosed. The magnifier can enlarge the viewing areas of various types of projection screens, and also display screens of electronic devices.

### CROSS-REFERENCE TO RELATED APPLICATIONS

This invention claims priority to U.S. Provisional Application No. 60/780,555, which was filed on Mar. 9, 2006.

### FIELD OF THE INVENTION

This invention relates generally to a device for magnifying electronic, non-electronic, digital, non-digital, analog, and non-analog viewing screens, display screens, and other forms of display/viewing screens or projection devices.

### BACKGROUND OF THE INVENTION

Users of modern digital devices such as digital cameras, cellphones, and iPods sometimes find it necessary to remove their reading glasses when they want to operate electronic devices, such as to take a digital picture. It is then necessary to put the glasses back on when they want to view the picture just taken The same problem exists when users try to view other display screens for various electronic, non-electronic, digital; non-digital, analog and non-analog screens. The problem is not necessarily the size of the screen, but also fading eyesight of many users.

### SUMMARY OF THE INVENTION

The invention is a magnifier which enlarges the viewing screens, projection screens and display screens commonly found on various electronic devices. These screens are found on electronic, non-electronic, digital, non-digital, analog, non-analog devices. The present invention provides enhanced and/or larger viewing area of viewing, display or projection screen on said devices.

### BRIEF DESCRIPTION OF THE DRAWINGS

FIGS. 1A-1F show views of an exemplary embodiment of the present invention;

FIGS. 2A-2E show the embodiment of FIGS. 1A-1F attached to a camera;

FIGS. 3A and 3B show the embodiment of FIGS. 1A-1F attached to a camera;

FIG. 4 shows an exemplary embodiment of the present invention attached to a cellphone;

FIG. 5 shows a further embodiment of the present invention attached to a cellphone in a closed position;

FIGS. 6A-6B shows another embodiment of the present invention attached to an iPod;

FIGS. 7 and 8 shows an embodiment of the magnifier attached to the display of a photoprinter;

FIG. 9 shows a further embodiment of the present invention

FIG. 10 shows the embodiment of FIG. 9 attached to a camera;

FIG. 11 shows yet another embodiment of the present invention;

FIG. 12 shows yet another embodiment of the present invention;

FIG. 13 shows a modification to the embodiment of FIG. 12;

FIG. 14A-14E show yet another embodiment of the present invention; and

FIGS. 15A-C show yet another embodiment of the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

The present invention is a magnifier to be attached to viewing screens, projection screens and display screens of electronic, non-electronic, digital, non-digital, analog, non-analog screens. This is done for the purpose of enhanced and/or larger viewing area of viewing, display or projection screen on those devices.

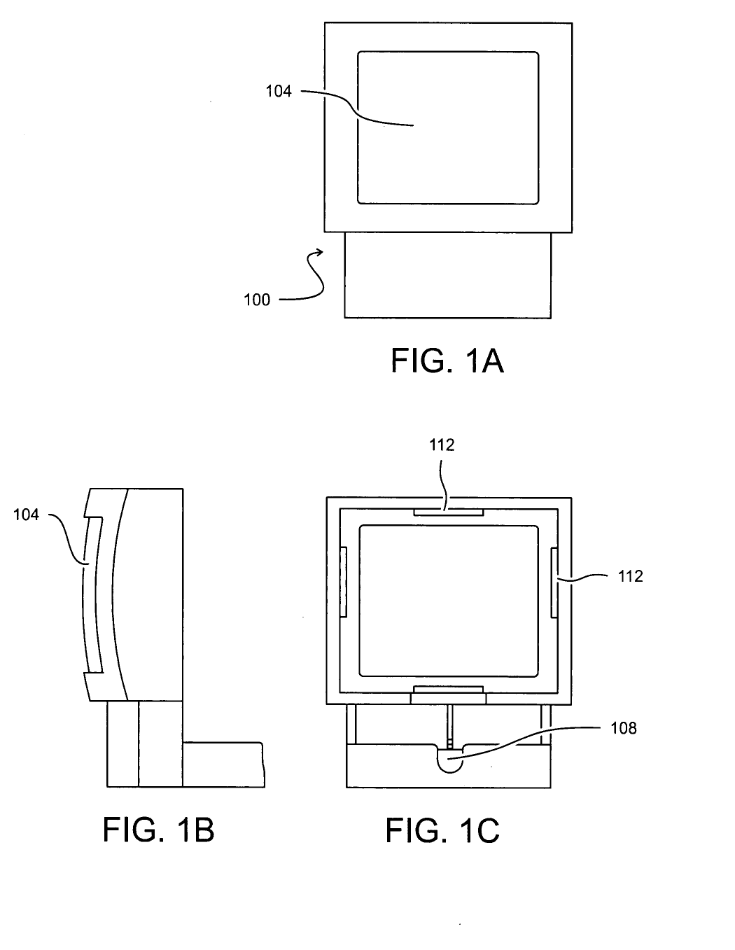

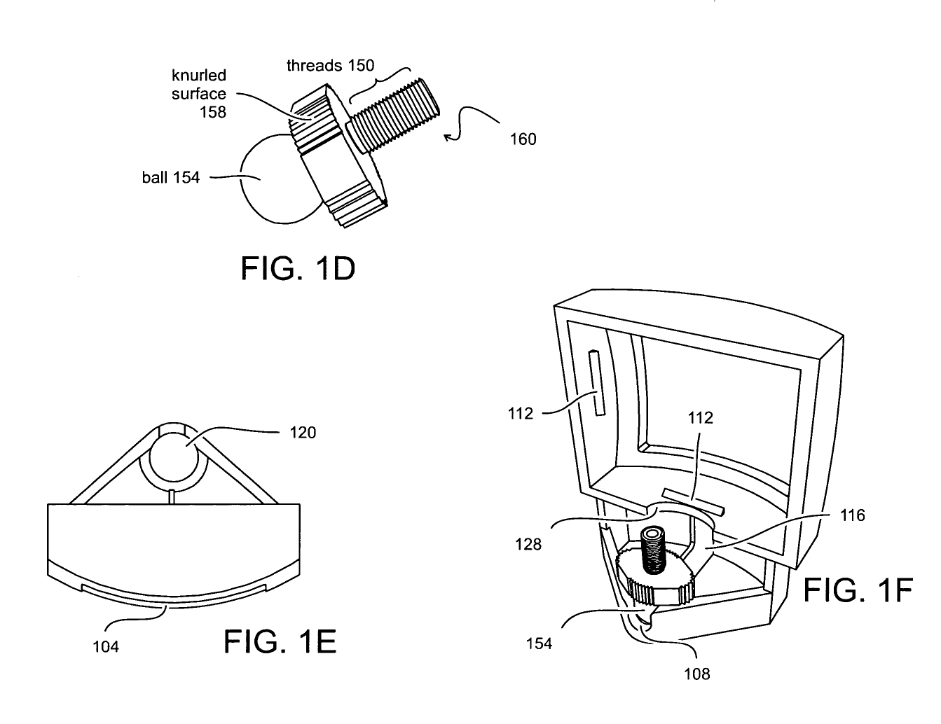

FIGS. 1A-iF show various views of a magnifier 100 of the present invention, which has a viewing area 104 comprising a curved lens. FIGS. 1B, 1D, and 1E show an exemplary curvature of the viewing area 104, although the present invention should not be considered as limited exclusively thereto.

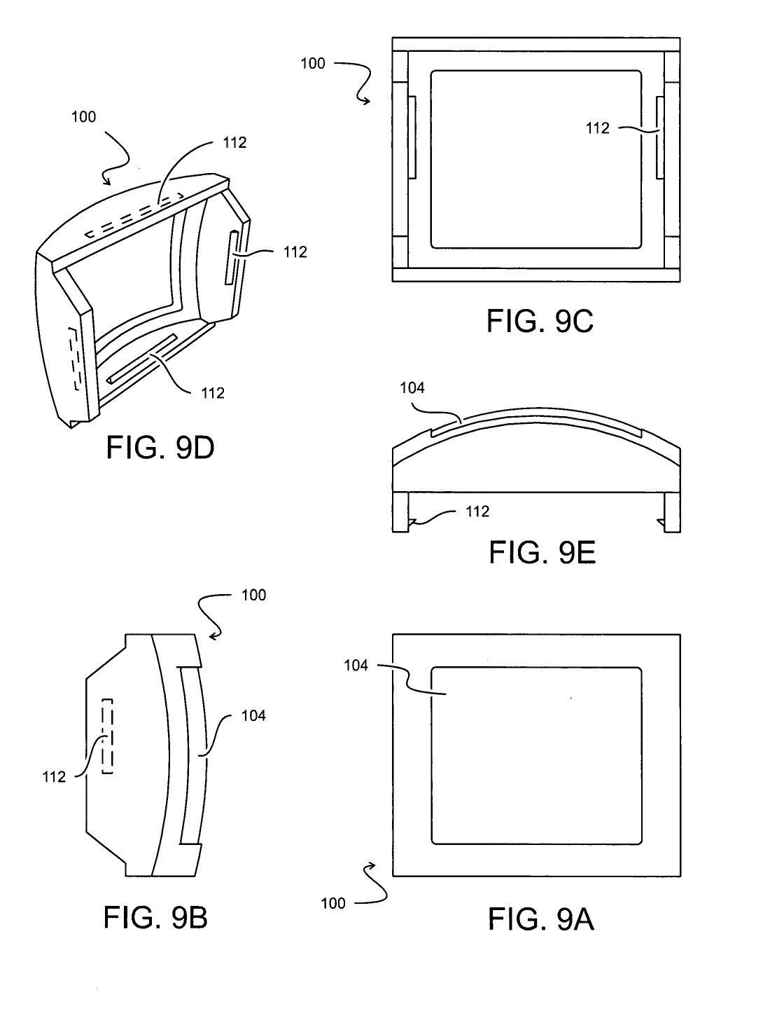

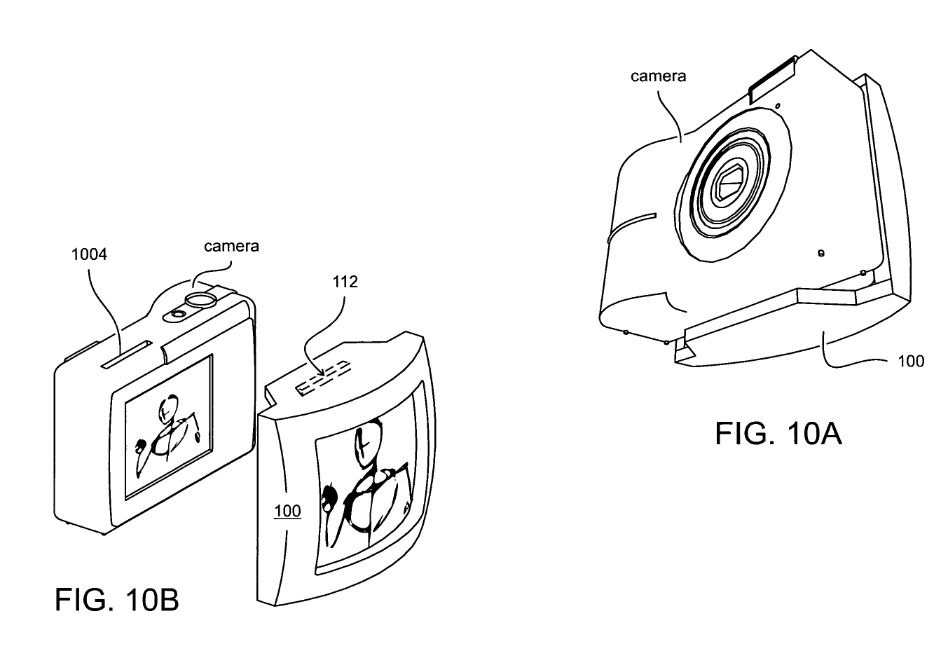

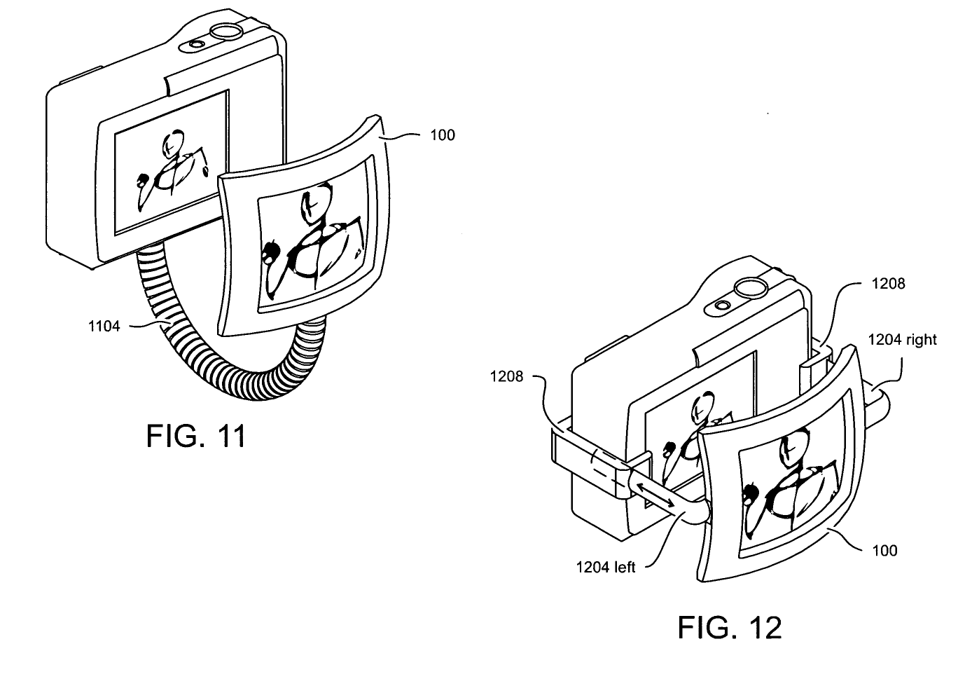

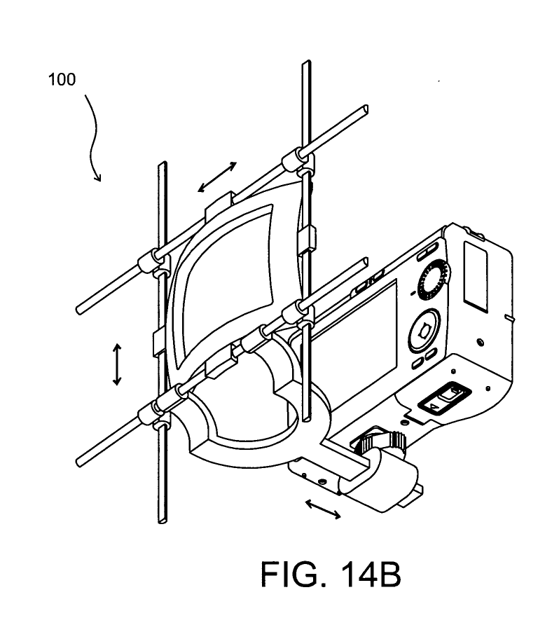

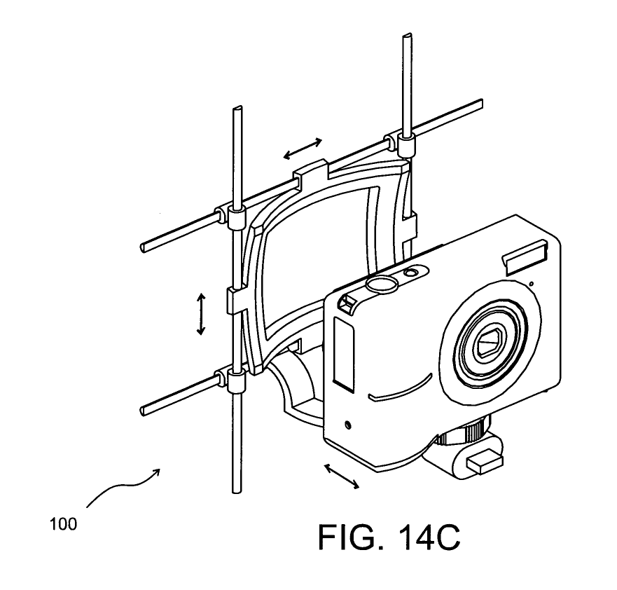

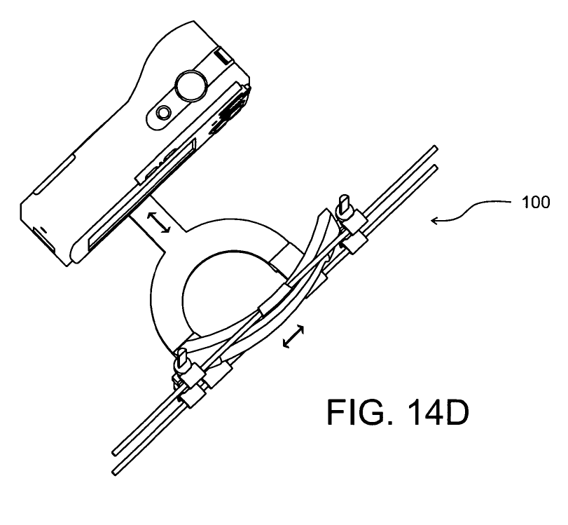

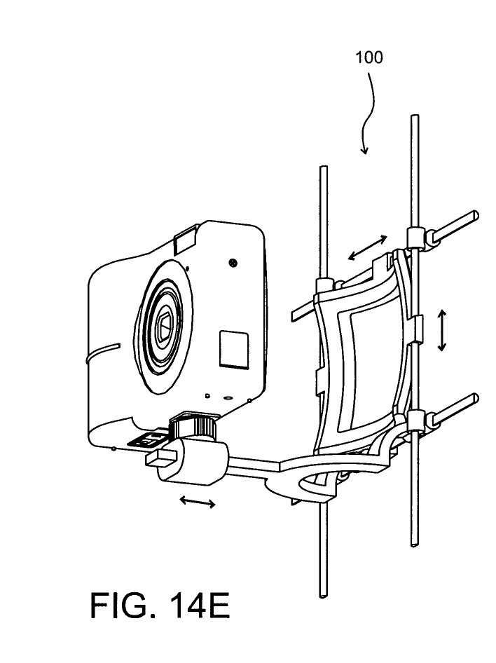

FIG. 1C shows an aperture 108 which can be used to admit a mechanism for attaching the magnifier 100 to the camera. Many digital cameras come equipped with threaded areas for admitting a threaded protruding member from a tripod. Various embodiments of the present invention can take advantage of this feature. This is useful because there can be many different body-sizes and body-shapes of digital cameras. Although the present invention can be molded to fit exactly and specifically with a particular camera, such as shown in FIGS. 9 and 10, it is also advantageous to have an embodiment which attaches via the threaded area that comes on many cameras. More examples of this are shown in FIGS. 11 and 14.

FIG. 1C also shows detents 112 which are used to removably attach the magnifier 100 to the device being magnified. Also, FIG. 1D shows a reinforcing rib 116 for strengthening the internal structure and moldability of the magnifier 100, and also shows a curvature 128 for admitting a protrusion or bump present on the device being magnified. The curvature 128 can also function to permit rotation of an attachment mechanism.

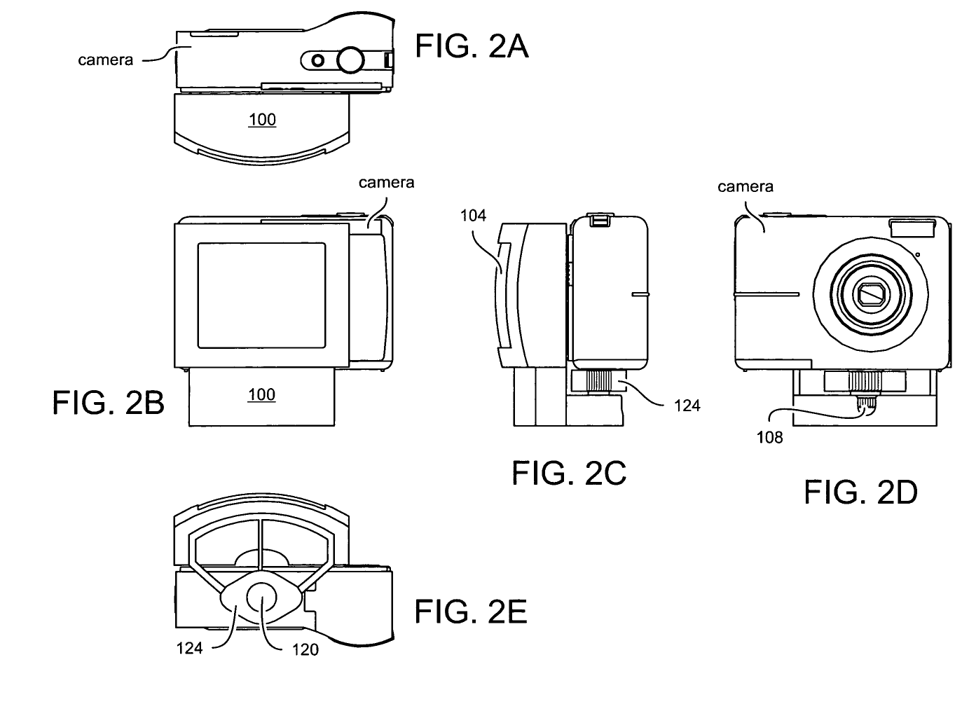

FIG. 1D shows an exemplary finger-tightenable ball screw 160 for fitting the magnifier 100 to a camera or other device. The screw 160 has a threaded surface 150, a ball 154, and knurled surface 124. The threaded surface 150 is for matching up with the threaded aperture present on many digital cameras. The ball 154 is useful because the screw 160 can be loosed but not detached, so that the magnifier 100 is still engaged with the camera but not attached directly to it. The magnifier 100 can then be rotated out of the way of the viewer, with the ball 154 acting as a rotational surface working inside the aperture 108. The magnifier 100 can then either be removed entirely, or re-installed back into working, functional position such as that shown in FIG. 2.

FIG. 1E shows more detail of the aperture 120 for admitting a fastening member, such as but not limited to the finger-tightened ball screw 160 shown herein. From FIG. 1F it is apparent that the ball 154 can be located inside the aperture 108. However, this implementation is but for exemplary purposes only, so that the present invention should not be considered as limited exclusively thereto.

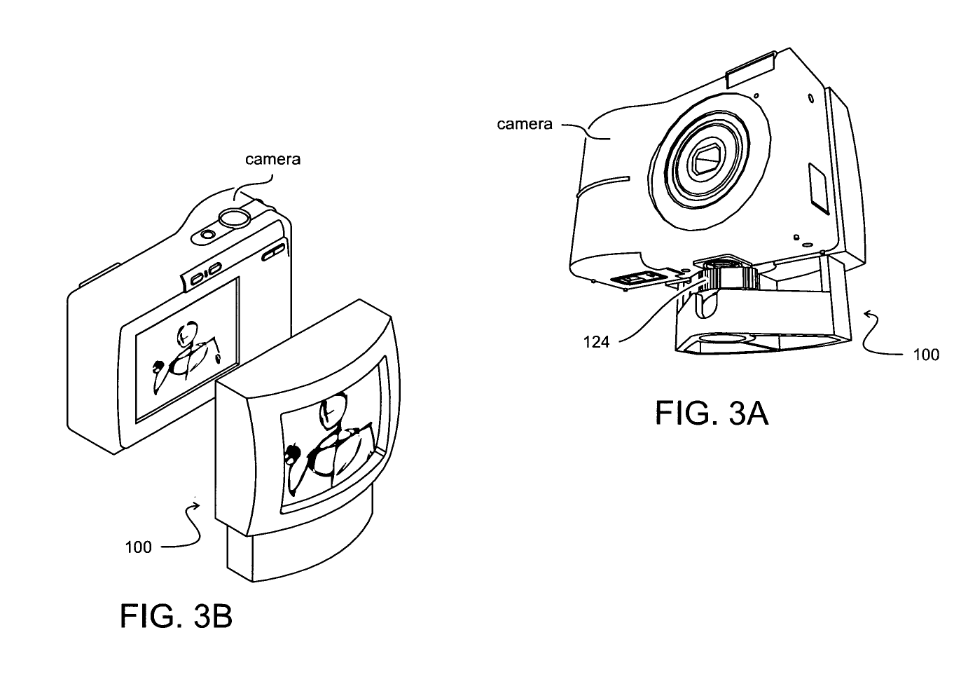

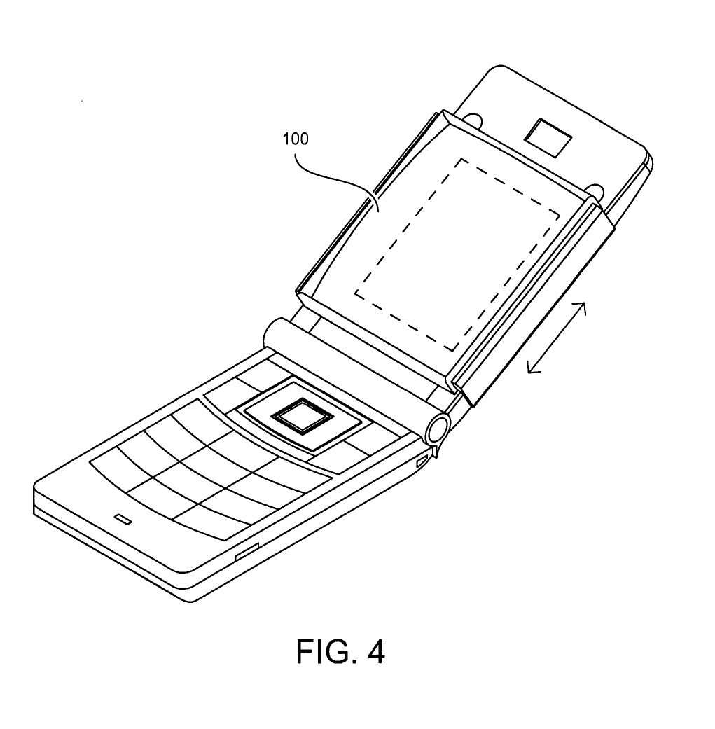

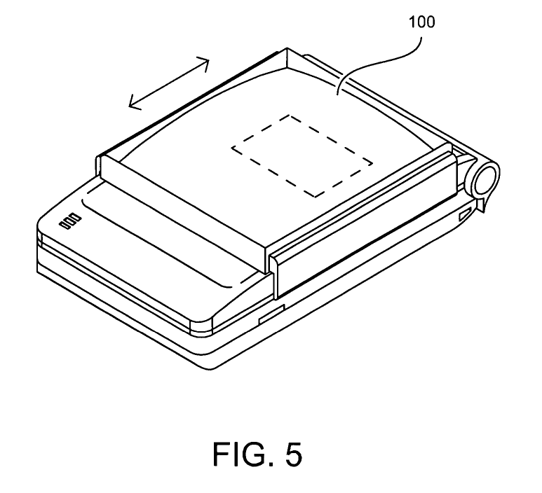

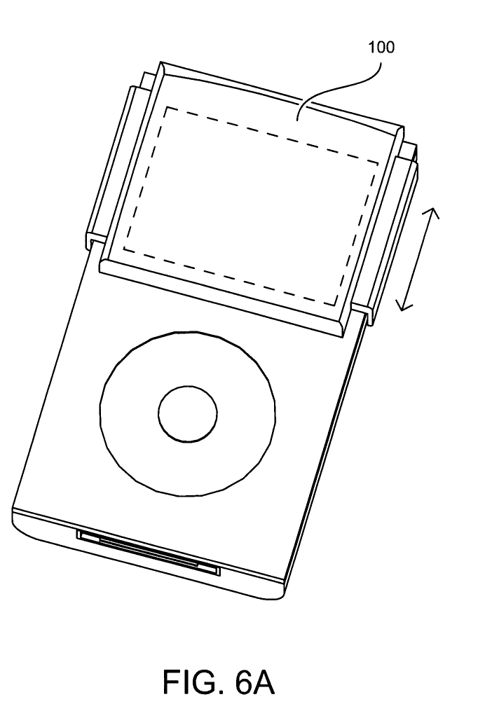

Additionally, although the representations in FIGS. 1A-1F contain specific features and molding concepts, these are but for exemplary purposes only. To that end, FIGS. 2A-2E and 3A-3B show the magnifier 100 attached to an exemplary digital camera having a display. However, it is to be noted that the present invention should not be considered as limited exclusively to the features shown in FIGS. 1A-1F. For example, the curvature 128 is meant to accommodate the specific camera shown in FIGS. 2A-2E and 3A-3B, but many other implementations and embodiments are contemplated within the spirit and scope of the present invention, many of which may not have a curvature 128.

FIGS. 2A-2E and 3A show some of the same views as FIGS. 1A-1E, but with the magnifier 100 actually attached to a camera. Although not shown in FIGS. 2A-2E and 3A-3B, the detents 112 assist in securing the magnifier 100 to the body of the camera.

As shown in FIGS. 2E and 3B, the finger-tightenable ball screw 160 can be used to attach devices through a tripod receptor commonly found on many digital cameras and other devices. FIGS. 2E and 3B show exemplary knurls 124 present on the finger-tightenable ball screw 160 as they are admitted through the aperture 120. However, other types of finger-accessibility besides knurls are also contemplated within the spirit and scope of the present invention.

In addition the ball screw 160, other forms of attachment for the present invention can include but are not limited to VELCRO™, double sided tape, custom made attachments, form-fitting attachments, and universal attachments.

The frame of the magnifier 100 of the present invention can be constructed of a variety of plastic resins, and can then be separately combined with a magnifying glass having the viewing surface 104. However, the entire unit can also be molded simultaneously. The body of the magnifier 100 can be manufactured or constructed of various materials such as but not limited to plastic, polymers, composites, resin, glass, wood and also paper products.

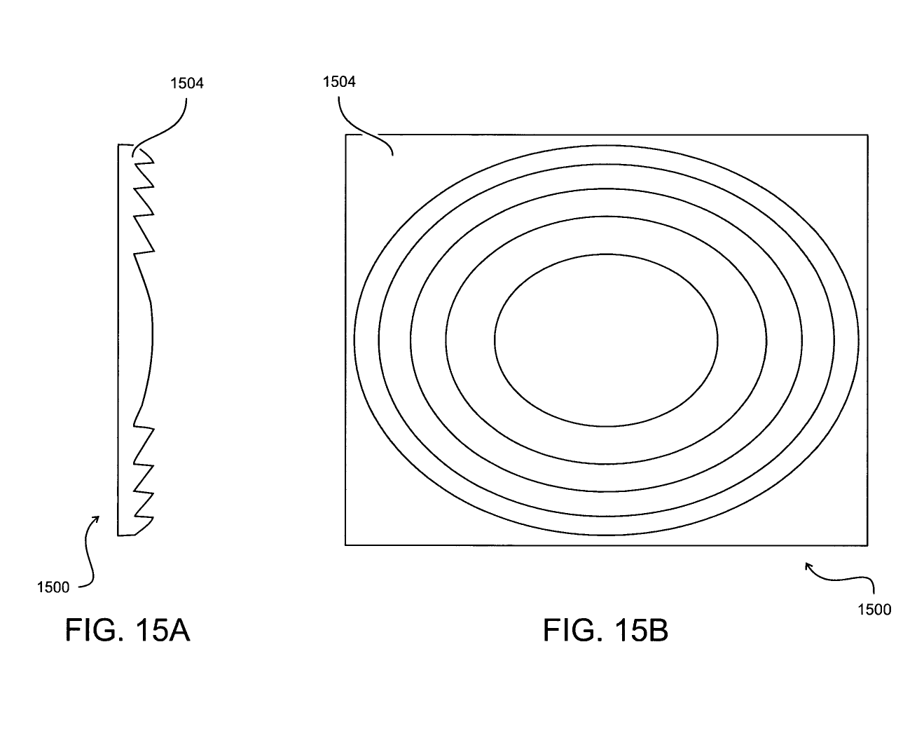

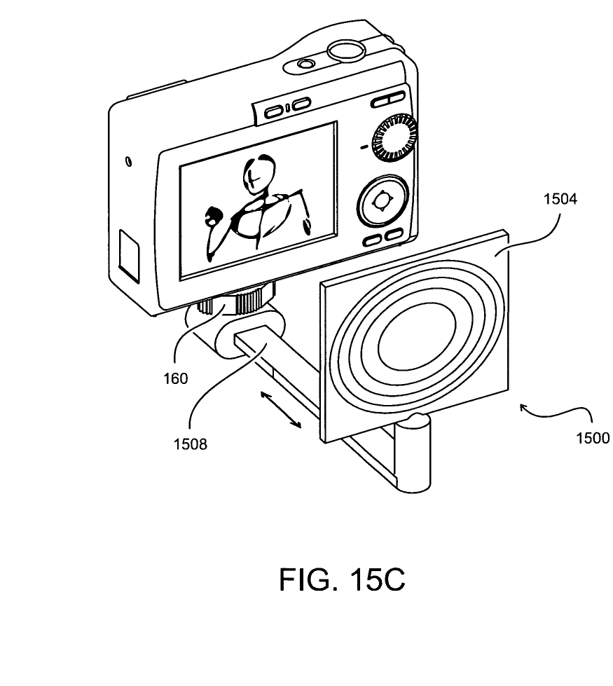

The viewing area 104 can be constructed of a magnifying lens ground to various reading glasses prescriptions. However, other forms of magnifying are also contemplated within the spirit and scope of the present invention, including but not limited to a fresnel lens mechanism, as shown in FIGS. 15A-15C. A wide variety of strengths of magnification for the viewing area 104 are contemplated within the spirit and scope of the present invention. Also, the viewing area 104 can be detached and removed from the magnifier itself. By substituting various viewing areas, a user could then adapt the magnifier 100 to have a variety of magnification strengths.

FIG. 4 shows one embodiment of the magnifier 100 attached to a cellphone. FIG. 5 shows the embodiment of FIG. 4 attached to a cellphone in the closed position. From FIGS. 4-5 it is apparent that the magnifier can be slidably installed and removed, but can also be clipped and unclipped.

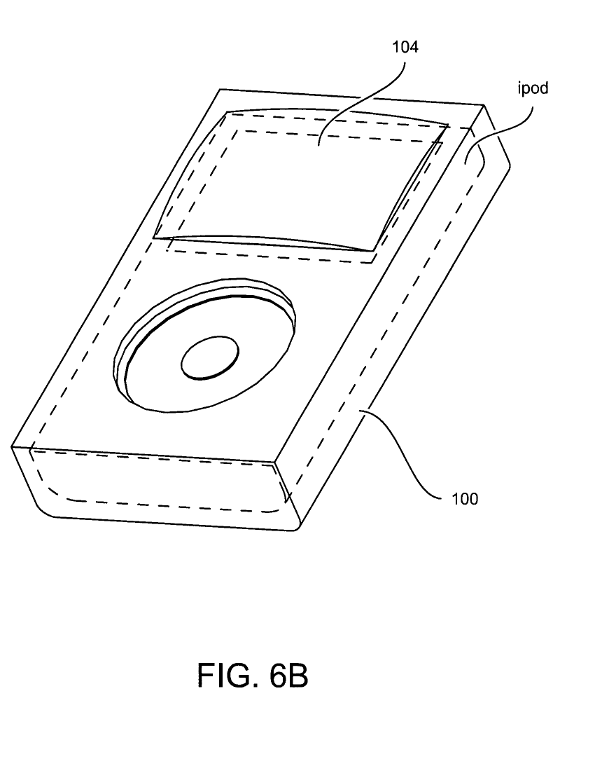

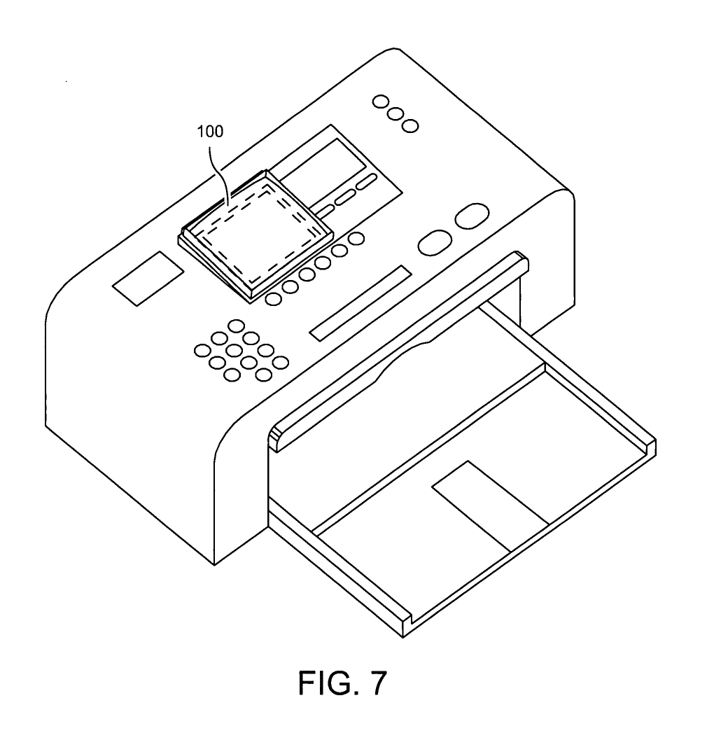

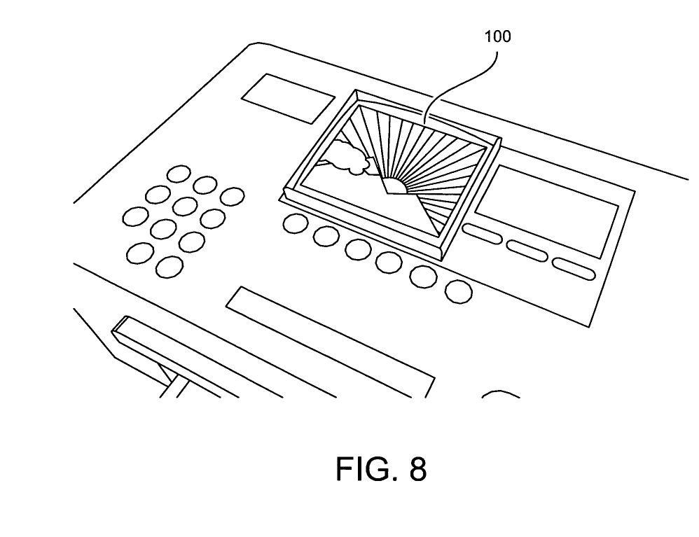

FIGS. 6A and 6B show two embodiments of the magnifier 100 attached to an iPod. In FIG. 6A, the magnifier 100 covers the display area only of the iPod. In FIG. 6B, the magnifier 100 is part of a plastic casing that completely surrounds and encloses the iPod. FIGS. 7 and 8 shows an embodiment of the magnifier 100 attached to the display of a photoprinter. An embodiment of the magnifier 100 could also be attached to the display of a camcorder.

FIG. 9 shows a further embodiment of the present invention, in which the detents 112 are the primary means of securing the magnifier 100 to a particular device having a display. To clarify this, FIG. 10 shows the magnifier 100 of FIG. 9 attached to a camera that has notches or apertures 1004 located therein. The magnifier 100 can thus make use of the existing features of a particular camera, to the extent they exist

FIG. 11 shows yet another embodiment of the magnifier 100, with a telescoping extension 1104 attached thereto. From FIG. 11 it is apparent that the extension 1104 also attaches to the threaded aperture present in many digital cameras.

FIG. 12 shows yet another embodiment of the present invention, in which sliding arms 1204Left and 1204Right are secured to a magnifier 100. The sliding arms 1204 are also secured to the camera via dips 1208. The sliding arms 1204Left and 1204Right can move within the dips 1208, thereby allowing a user to adjust the magnifier 100 while sighting it.

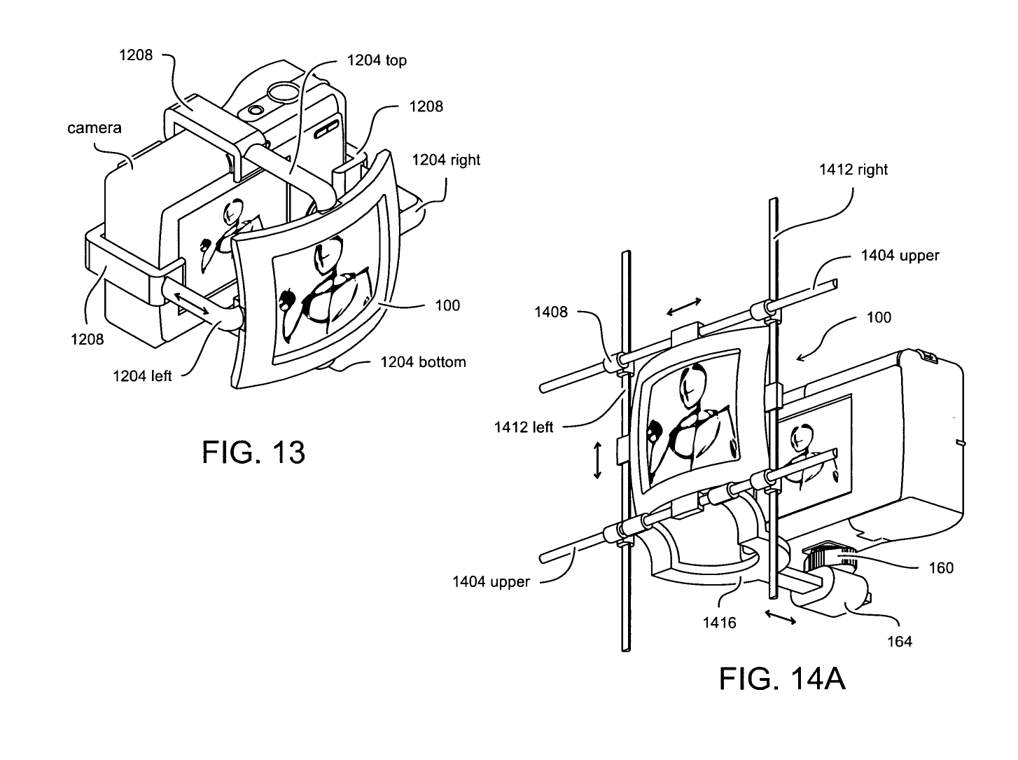

FIG. 13 shows a modification to the embodiment of FIG. 12, in which the sliding arms 1204Left and 1204Right are joined by sliding arms 1204Top and 1204Bottom.

FIGS.14A-14E show yet another embodiment of the present invention, in which a Y-shaped base 1416 supports a frame comprising horizontal members 1404 and vertical members 1412. These members 1404, 1412 are joined by multaxis securing members 1408. From FIG. 14A it is apparent that the magnifier 100 can be moved in three different directions within the frame formed by the horizontal and vertical members, thereby enabling a user to adjust the magnifier 100 to best suit their particular viewpoint

Within the embodiment of FIGS. 14A-14E, a sliding securing member 164 movably attaches the Y-shaped base 1416 to the camera or other device.

FIGS.15A-15C shows yet another embodiment of the present invention, in which the magnifier 1500 uses a fresnel lens 1504. The magnifier 1500 can be directly attached to a surface of a camera or other device, requiring only minimal securing mechanisms. Fresnel paper enables the construction of lenses of large aperture and short focal length without the weight and volume of material used in other types of lenses. As shown in FIG. 15A, the magnifier 1500 is thin because of its Fresnel surfaces, thus passing more light and allowing the viewing area of the camera or other device be visible over longer distances. FIG. 15B shows a plan view of the magnifier 1500 shown in FIG. 15A.

The fresnel lens 1504 used in the magnifier 1500 can be reinforced at the edges, so as to give it the desired rigidity to attach to the mount 1508. FIG. 15C show a magnifier 1500 attached to that camera by, for example, a ball screw 160.

It is anticipated that various changes may be made in the arrangement and operation of the system of the present invention without departing from the spirit and scope of the invention, as depicted in the following claims.

What is claimed is:

1. A magnifier to be attached to a device having a display, comprising:
a housing;
a viewing area, located in a center of the housing; and
fastening means, located on any one or more of the top, bottom, left, and right edges of the housing, for attaching to a body of the device;
wherein the viewing area is physically matched with the display so as to improve viewability for a user.

2. The magnifier of claim 1, further comprising:
an aperture, positioned on a bottom internal area of the magnifier, for admitting an attachment mechanism used in attaching the magnifier to the device.

3. The magnifier of claim 1, further comprising:
a plurality of detents, positioned within the interior of the housing, for removably attaching the magnifier to the device.

4. The magnifier of claim 1, further comprising:
a plurality of reinforcing ribs, positioned within the interior of the housing, for strengthening the internal structure and moldability of the magnifier.

5. The magnifier of claim 1, further comprising:
a curvature, positioned within the interior of the housing, for admitting a protrusion or bump present on the device being magnified.

6. The magnifier of claim 5, further comprising:
the curvature permits rotation of an attachment mechanism.

7. The magnifier of claim 2, further comprising:
a finger-tightenable ball screw for fitting the magnifier to the device.

8. The magnifier of claim 7, further comprising:
the ball screw has manufactured therein a threaded surface at a far end, a knurled surface in a middle area, and a ball at an opposing end.

9. The magnifier of claim 8, further comprising:
the ball screw can be loosened but not detached from the device, with the ball acting as a rotational surface working inside an aperture within the magnifier.

10. The magnifier of claim 1, further comprising:
the housing is constructed of plastic, and can then be separately combined with a magnifying glass thereby forming the viewing surface.

11. The magnifier of claim 1, further comprising:
The housing and viewing surface are manufactured simultaneously.

12. The magnifier of claim 1, further comprising:
the housing is manufactured polymer resins.

13. The magnifier of claim 1, wherein the viewing area further comprises a magnifying lens ground to various reading glasses prescriptions.

14. The magnifier of claim 1, further comprising:
the magnifier attaches to a cellphone.

15. The magnifier of claim 1, further comprising:
the magnifier attaches to a iPod.

16. The magnifier of claim 1, further comprising:
the magnifier attaches to a photoprinter.

17. The magnifier of claim 1, further comprising:
the magnifier attaches to a camcorder.

18. The magnifier of claim 1, further comprising:
a telescoping extension which connects the magnifier to the device via a pre-existing threaded attachment port positioned within the device.

19. The magnifier of claim 1, further comprising:
a plurality of sliding arms secured to the device via form fitting dips.

20. The magnifier of claim 1, further comprising:
a Y-shaped base supporting a frame comprising vertical and horizontal members, wherein the members are joined by multi-axis securing members.

21. The magnifier of claim 20, further comprising:
a sliding securing member movably attaches the Y-shaped base.

22. The magnifier of claim 1, wherein the viewing area further comprises a fresnel lens.
